(19) United States
(12) Patent Application Publication
(10) Pub. No.: US 2013/0053142 A1
(43) Pub. Date: Feb. 28, 2013

(54) COMPUTER-IMPLEMENTED REAL-TIME REALITY BASED DATA GAME AND METHODS

(71) Applicants: Matthew Hastings KRESS, Laguna Niguel, CA (US); Erin Michelle LEAVITT, Marina Del Rey, CA (US); Geoffrey Barrett GREENBLATT, New York, NY (US)

(72) Inventors: Matthew Hastings KRESS, Laguna Niguel, CA (US); Erin Michelle LEAVITT, Marina Del Rey, CA (US); Geoffrey Barrett GREENBLATT, New York, NY (US)

(73) Assignee: TEMPUS GAMING, LLC, Laguna Niguel, CA (US)

(21) Appl. No.: 13/592,828

(22) Filed: Aug. 23, 2012

Related U.S. Application Data
(60) Provisional application No. 61/526,645, filed on Aug. 23, 2011.

(51) Int. Cl. A63F 13/12

(52) U.S. Cl. 463/31; 463/42

(57) ABSTRACT

A computer-implemented system and method of game playing between a server and a client interface is described. The game is adapted to integrate social networking with real-world based data feed from a plurality of data feed sources in real-time.

### CROSS REFERENCE

The present application claims priority to U.S. Provisional Patent Application No. 61/526,645, filed on Aug. 23, 2011, which is incorporated herein by reference in its entirety.

### FIELD

The present disclosure relates to game playing while integrating a social network. More in particular, it relates to computer-implemented real-time reality based data game and methods.

### BACKGROUND

Social networking games are very popular of late. A social networking game is a software-based program that is hosted on a social network that executes the game, and which can be played by any number of players simultaneously. Some social networking games take the form of a so-called “virtual-reality game”, meaning that they have digital representations of real-world locations, events and situations, but often are not based on real-time information. Thus, these types of games are a departure from reality which can alienate or affect the interest of a player of such games.

### SUMMARY

According to a first aspect, a computer-implemented method for playing a game is described, the method comprising: receiving, in a server that supports a gaming platform, a plurality of real-time data feed related to a specific category; aggregating, by the server, the plurality of real-time data feeds to present an aggregated data feed related to the specific category; displaying, on a client computer the aggregated data feed of the specific category; receiving a selection by a player, of one or more data feed of the aggregated data feed; and providing points by the server to the player upon receiving the selection of the one or more data feed based on set rules.

According to a second aspect, a computer-implemented system for playing a real-time reality based data game is described, the system comprising: a server comprising a live data feed aggregator adapted to receive a plurality of real-time data feeds related to a specific category, and aggregates the plurality of real-time data feeds into an aggregated data feed; one or more client computers having a display, the one or more client computers being adapted to receive user input to play the game; and a game engine that executes the game using the display, the game engine communicating with one or more client computers for receiving user input to play the game.

According to a third aspect, a computer-implemented system for playing a game is described, the system comprising: a client computer having a screen for displaying a series of graphical user interfaces, the graphical user interfaces comprising a home screen for displaying an avatar image, a list of real-time data feed, and a plurality of navigational buttons for navigating from the home screen to a plurality of different graphical user interface pages, wherein the list of real-time data feed comprises headlines of real-world news stories associated with a specific category, wherein the screen is adapted to display additional navigational buttons when the headline from the list of real-time data feed is selected by a player playing the game, the additional navigational buttons adapted to allow the player to read the selected real-world news, comment about the selected real-world news, and/or virtually selected the selected real-world news, and wherein the player earns game points by virtually selecting the selected real-world news.

### BRIEF DESCRIPTION OF THE DRAWINGS

The systems and methods of the present disclosure will be described with reference to several figures, which are provided herewith as non-limiting examples. In particular:

FIG. 1A shows an overview of an exemplary system for playing a game in accordance with the embodiments of the present disclosure.

FIG. 1B is an exemplary functional block diagram of a game system that can be hosted on a networking platform.

FIGS. 2-8 show various screenshots of an exemplary implementation of the game according to various embodiments of the present disclosure.

FIGS. 9-22 show screenshots showing gameplay flow on a client interface of an exemplary implementation of the embodiments of the present disclosure.

### DETAILED DESCRIPTION

In general, the present disclosure describes a computer-implemented real-time reality based data game and methods of playing such game. In some aspects, the game is centered around a player's ability to select a news story based on real-time data feeds. In these aspects, players can act like a news collector (e.g., paparazzi) and find real or virtual value for their news selection in any number of information exchanges that can take place on a gaming platform that can be integrated with a social networking platform.

The computer-implemented game is based on real-time data feeds of real persons of interest, and reality-based events and geographical locations relating to those persons of interest. The game can entail collecting information about the persons of interest. In some implementations, the persons of interest are celebrities, such as movie stars, sports figures, politicians, etc., and the game is optimally hosted on a computer-implemented server such as a cloud based server adapted to integrate with social networks, so as to enable a number of players to cooperate with a number of other players in a “network” (e.g., network of friends, cliques, league, etc.) or compete against each other while keeping tabs of the progress and advancement of their “friends” or competitors, or any other persons associated with the game. A person skilled in the art would recognize that the terms “friends”, “clique”, “league”, and any other terms pertaining to a network can be used interchangeably to refer to the same thing. The players can have a client interface such as a smartphone, tablet, or a personal computer with the game installed on the client interface as a software application. The client terminal can be connected over a network such as the Internet, which in turn, can be connected to the hosted server. Therefore, when the players play the game on the client interface, the game can be played over the network against other players using other client interfaces.

In some embodiments, the game can entail users using taking virtual photos of celebrities as the occurrence happens in the real world. Although the terms taking a “photo” or a “picture” are used in the present disclosure, such terms are intended to refer to “selecting” a news story on the client terminal, for example, by clicking on an icon or a button. The celebrities and related situations and environments can be based on real-world occurrences that are being reported to players via the computer implemented network (e.g., by way of data feed).

The elements such as, but not limited to photos, celebrities, situations, locations and environment are based on real world occurrences as they take place.

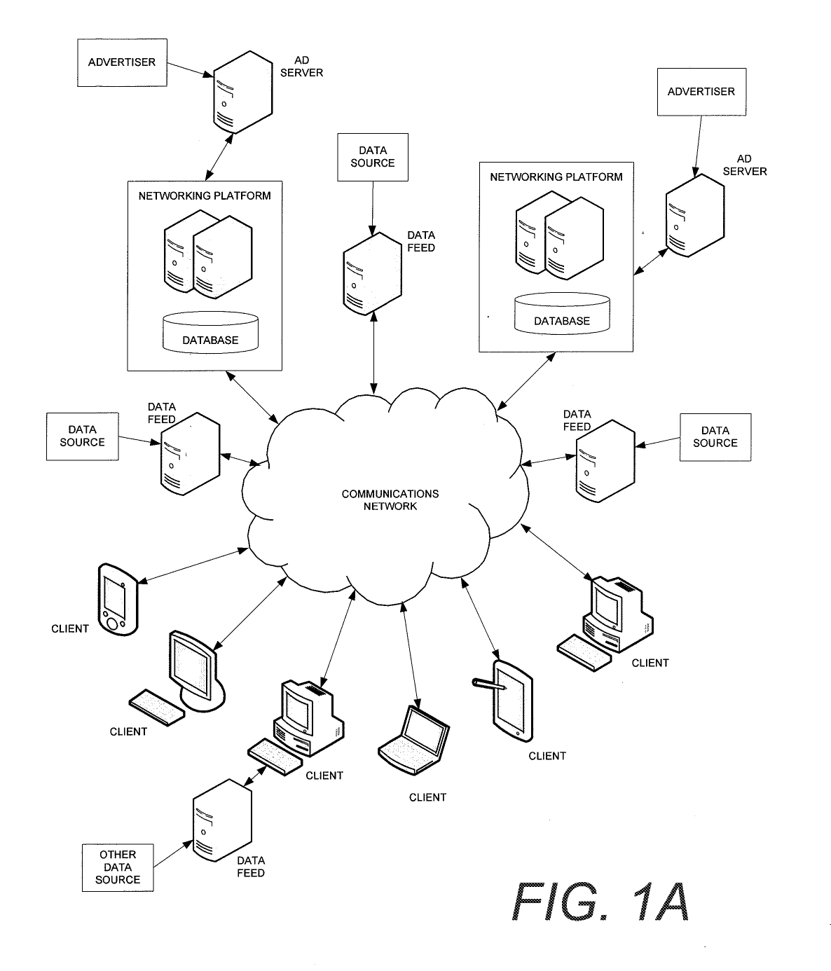

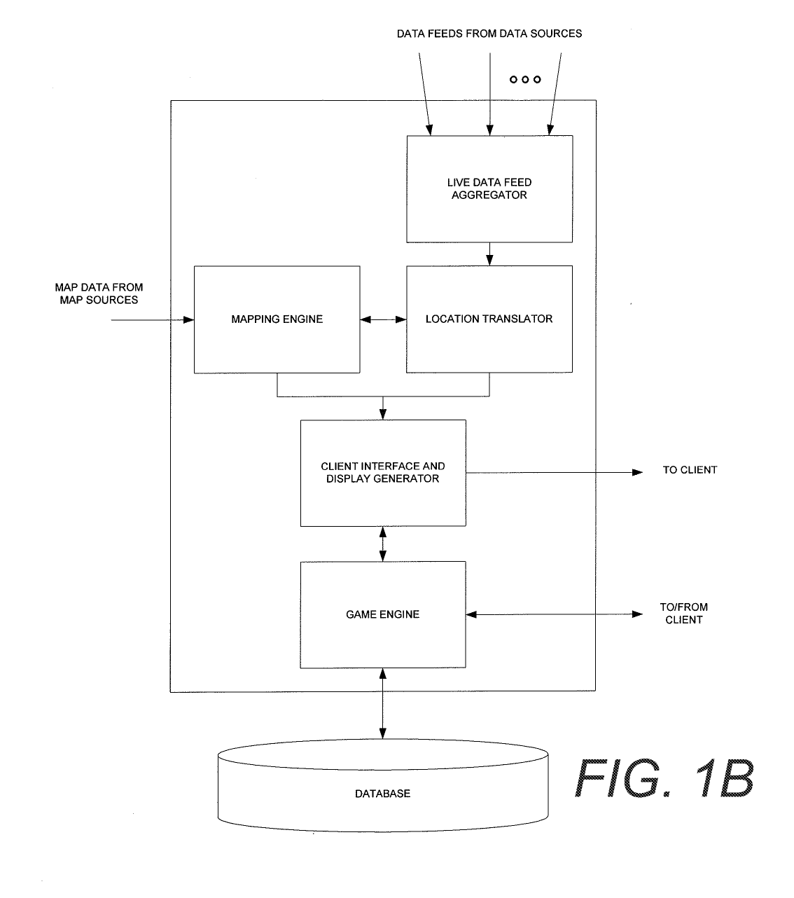

FIG. 1A shows a system for playing a game in accordance with some implementations. Each user uses a client interface, each designated as “client” or a “client computer”, to access the game via a communications network, e.g., the Internet or Web. The game can be hosted by one or more networking platforms, such as mobile application (e.g., IPHONE® app, ANDROID® app), web based browser, or any social networking system that enables multiple clients to communicate with various servers and other clients. The client can be any computer such as a laptop, a desktop, a smartphone, a tablet computer, or any other computing device that can display the representation of the game and optionally, a geographical location related to the game. The clients can also access one or more data feeds that provide real-time or near real-time data from one or more data sources. A data source can be a news or gossip site, a blog, or a TWITTER® feed. The data feeds can be a server connected with the communications network, or even with a networking platform for embedded real-time data feeds directly in the network. In some cases, a client may obtain data from one or more other data sources, and communicate directly with such data feed to bypass the communications network. Such other data sources can be a text message, phone call, or private communications network. Clients may also receive data from one or more advertisers through ad servers, which can also be integrated with one or more networking platforms and/or operating systems and their application ecosystems.

A player of the game accesses the game from a client interface, which is connected with a network such as the Internet. The game is hosted by one or more server computers that receive the real-time data feeds and serve the real-time data feeds to the client computer either separately or as an aggregate data feed. Alternatively, the game is executed on a server computer, and one or more separate server computers are accessed by each client interface to establish the real-time data feeds. In some implementations, multiple users play the game from multiple client interfaces, preferably simultaneously such that any user can view the status and/or progress of any other user. As used herein, the term “user” refers to a player of the game.

The real-time data feeds can be displayed in a section or a window of a graphical user interface (GUI) displayed by the client interface. In some implementations, the section or window of the GUI displays an aggregate of multiple real-time data feeds. The real-time data feeds can be a plurality of specific categories such as, gossip sites (POP SUGAR®), news sites (e.g., TMZ®, CNN®, ESPN®), or blogs related to targeted news stories for playing the game. Other real-time data providing sites can be accessed, such as TWITTER® feeds, text messaging services, or other real-time micro-blogging services, which players can access and use as well within the game. In some implementations, players, via the aggregator, can have access to a relationship for legal access to the content of one or more of the real-time data feeds, which helps drive traffic to the sites associated with the real-time data feeds.

In some embodiments, the real-time reality-based data feeds can be real simple syndicates (RSS), of targeted news stories (e.g., celebrity gossip, sports, music, politics, exercise, food), including real-time information about a situation, location and/or environment associated with such news stories. The data feeds can be arranged to scroll in real-time within each user's display game. In some implementations, two or more data feeds can be aggregated in one scrolling window of the display. In some cases, a user needs to have a relationship to, such as a paid subscription with, one or more particular targeted data feeds, for legal access to the content provided by those feeds. This can promote and drive traffic to independent bloggers and sites that provide such gossip content.

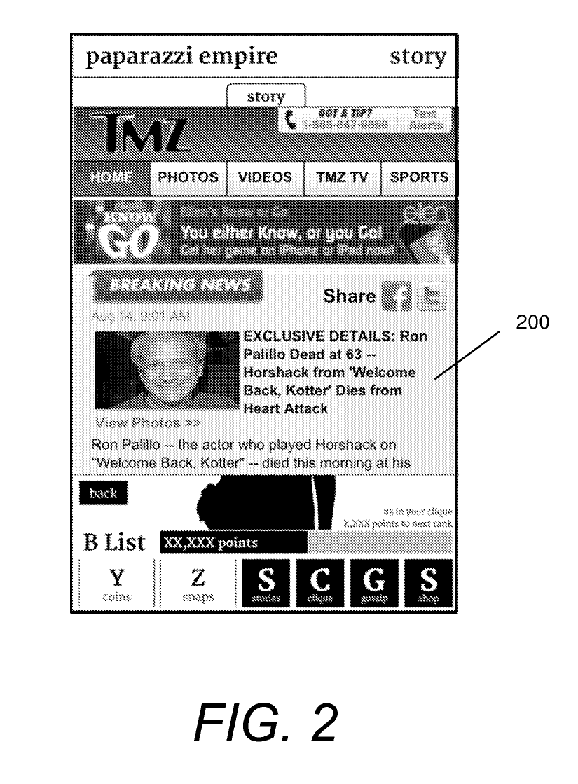

In some embodiments, story aggregation can be used as news sources for the players to learn and read about real-world news and their accompanying stories. Such stories can appear as a webshot (200) or directly imported news feed on the display of the client interface as shown in FIG. 2, in an untouched format from the original source when the player clicks the “read” button (201) on the headlines page.

In some embodiments, real-world locations of the news can also be integrated with the data feed. Such locations can be powered by a digital map service, such as GOOGLE® Maps or other map sources that have the ability to calculate variables such as travel times, traffic, air conditions, or links to weather. Fictional locations can also be used. The fictional locations can be constructed and displayed as a virtual city, with buildings, restaurants, recreational parks, roads, automobiles, or anything that can exist in a real city. The game can also create fictional circumstances and feed options to the user through gameplay. Alternatively, the game map can filter and exclude various location objects that may not be relevant to the play of the game.

FIG. 1B is a functional block diagram of a game system that can be hosted on a networking platform. The networking platform can be centralized in a single server or bank of servers, or distributed among a large number of geographically dispersed servers connected in a network. The game system can include a live data feed aggregator on the server that aggregates a number of real-time data feeds, such as, for example and not limited to news services, celebrity gossip traffic, blog sites or messaging feeds. A mapping engine receives map data from a map source, such as GOOGLE® Maps or other internet mapping service that will enable a client interface and display generator to provide a map to a player via their client computer. A location translator on the server can translate data from the live data feed aggregator into real-time locations for display in the map provided to the client. Players can play the game executed by a game engine, and optionally using a map with locations of celebrities, as will be described in further detail below.

The following describes an operation of the game. It will be understood that, unless indicated otherwise, terms such as “photo”, “celebrity” or other real-world objects, are being described as a virtual representation of the objects in a display on a computer. In other words, in playing the game, a player can react to breaking stories occurring in real-time to look through a list of data feed on the player's client terminal and selectively select a news story. Competitors will be in a player's personal network, such as a user's FACEBOOK® “friends”, as will teammates. In alternative implementations, players or groups of players from different social networks can compete against each other.

Players can perform steps on a client computer to “take” a photo of a celebrity. By “taking” a virtual photo of the celebrity, the player is selecting a news feed from a plurality of aggregated news feed data and sending this information to the server that is hosting the game. The server receives the information that this player has selected (e.g., took a photo) a news feed and accordingly, assigns this player a certain number of points. In some implementations, a game-based value of each photo can be calculated using the following exemplary factors in an algorithm:

Points can be earned for each story that is photographed (e.g., snapped). For example, a player can snap a picture of Kim and Kanye leaving a restaurant and earn 10 points. Additionally, the player can earn two additional points for snapping the picture within the first hour that the story is reported. Therefore, the sooner the player can snap a picture of a news story, the more points the player can earn. When points are earned, the player can be notified and can post this as an announcement on his social network page (e.g., FACEBOOK® wall or TWEET®). Additional points can be earned later based on the popularity of the new story. For example, if the news that the player took a picture of becomes very popular (e.g., many other player also take a picture of the same news), then each of the players that took of picture of this news will earn additional points. Point totals will be used to determine winners of virtual and/or real world prizes after a specific amount of time. For example, on a weekly basis, the player with the most points in a group can earn exclusive virtual goods for free.

Badges can be earned based on accomplishments in addition to earning points. For example, if a player snaps five pictures of Kim, the player can earn a Kim Fan Badge, whereas snapping 25 pictures of Kim can earn the player a Kim BFF Badge. Other examples can include, Friend Badges or Most Popular Badge based on the number of friends added to the player's network of friends. Moreover, a player can earn a Hollywood Starlet Badge by maintaining A-List status for a given length of time. When players earn a badge, a notification is displayed to the player. In addition to earning badges, players can be awarded virtual good for achieving certain badges. For example, a player can earn a Mariah Badge by snapping three pictures of Mariah Carey, and is rewarded with a charm bracelet from the virtual store.

Status can be earned by achieving weekly activity goals. By way of example and not of limitation, there can be four status levels: A-List, B-List, C-List, D-List, each level which can be achieved by earning a certain amount of points. For example, having less than 50 points will place the player in D-List, while once the player earns more than 50 points, the player will achieve C-List. Upon earning 75 points, the player can achieve B-List, and upon earning 100 points, the player can achieve A-List. Moreover, a player can earn in-game rewards and in-game currency which can be used at the virtual store according to various combinations of earning points, badges, and status during certain time periods. The player's status is displayed on the player's home screen. In some embodiments, the players can earn real-world prizes based on their in-game achievements.

Those of skill in the art will recognize that other algorithms and rating factors can be used. Players are represented by personally-created avatars in and around the game.

The game can provide virtual goods that can allow a user to enhance the player's game play. Virtual goods can also be available to dress and accessorize avatars (e.g., figures that represent the player and displayed on the user interface).

When a player initially creates an account with the game platform via the client interface, the player will be able to create and design an avatar. For example, the player will be able to select the gender, body type, facial features, skin color, hair color and clothing. Limited selections will be provided initially for free and further selections can be purchased as virtual goods in a virtual store when game play starts.

In some embodiments, the players can press the “shop” button on the home screen which can direct the players to a page that allows them to purchase or obtain for free, virtual goods such as, clothes, accessories, shoes, hairstyles, and pets, in a virtual store. In the virtual store, thumbnails of the virtual goods will be visible to the player, which will allow them to select the desired items they wish to purchase. In some embodiments, the player can go to third party websites, such as ITUNES® app store to purchase or obtain virtual goods. Once the virtual goods are obtained, the virtual goods will be available in their account so the players can use their virtual goods to change their avatars at any time. The players can also get rid of the virtual goods if they are no longer desired. In some embodiments, certain virtual goods may only be available for a limited time or to a limited number of people. Players can gift virtual goods to their friends or other players. The players can tell their friends about their purchases or gifts by posting on social media such as FACEBOOK® or TWITTER®, as well as see which fashions are trending. In some embodiments, the players can purchase real-world gifts for others through the game. For example, a player can buy actual movie tickets to their chosen theater for a film that is being promoted in the game.

In some embodiments, the virtual stores can be grouped into plurality of virtual stores similar to real world stores. For example, there can be a trendy boutique named Greg Segal that sells clothing, shoes, purses, sunglasses, and other fashion accessories, a trendy salon called Jacques Pierre for haircuts, makeups and manicures/pedicures, a pet store for dogs, cats, and other animals to appear with the avatar, and a general market that sells a variety of random items such as gifts, champagne, and caviar. Furthermore, the virtual store can also sell background pictures (e.g., picture of a Los Angeles, Miami, New York City, stadiums, restaurants, and other landmarks) in which the players can add to their personal profile, avatar, or their phones. By way of example and not of limitation, the personal avatar can be displayed over a background of some scenery in Los Angeles, or the wallpaper background of the player's client terminal (e.g., phone) can display a scenery of New York City or a real-world display (e.g., invitations). The players will be able to try out the virtual goods before actually purchasing the virtual goods, similar to a real world person trying on clothes at the clothing store before buying it. The players can also purchase game features such as restraining orders against other players, or ridealongs where the players can be absent from game playing for a set period of time without losing status or other penalties. Restraining orders can hide the player's actions from another player for a set amount of time. For example, if player A bought a restraining order against player B for one week, then player B will be be able to see player A′s in-game actions for one week. The virtual store purchases can be made with in-game currency won through game play or purchased in coin bundles in the virtual store. Payment can be routed through phone carriers or third party app stores (e.g., ITUNES® app store, ANDROID® app store, FACEBOOK® app store).

The players can use their real world name for their avatar or create a user-selected name. The players can also create and change a personalized slogan for their avatar. Once their avatar is created, the player will enter the virtual world and begin game play.

In some embodiments, mini games (e.g., trivia, casual games) can be available in a game channel in which players can earn points that can be used in the virtual store located on the server. Furthermore, the points earned by playing the mini games can also contribute additional points to the player's total points in the real world reality based data game. Moreover, the mini games can be purchased from the virtual store and played alone or against other players. By way of example and not of limitation, trivia games can be themed such as movie trivia, gossip trivia, entertainment trivia, who dated/married/divorced who trivia, entertainment awards trivia. Casual games can be third party games such as BEJEWELED BLITZ®, ANGRY BIRDS®, or DR. MARIO® with added features that can include paparazzi/celebrity themes.

Information that is stored and shown for each player can include current activity, pictures taken, and avatar representation of the player. Players can add their own posts/updates and other players can “comment” or “like” posts as they see fit, e.g., gloat/advertise/brag about the latest “hot” photo taken.

The game can also generate obstacles, which can include potential for a nemesis avatar/character to sabotage a player. The player can use strategy/virtual goods to counter obstacles. An example of an obstacle can be, for example, the restraining order described previously.

The game further creates bonus opportunities for players. Examples can include the players uploading their actual photos of real-life celebrities in personal situations, which they can redeem for coins or points.

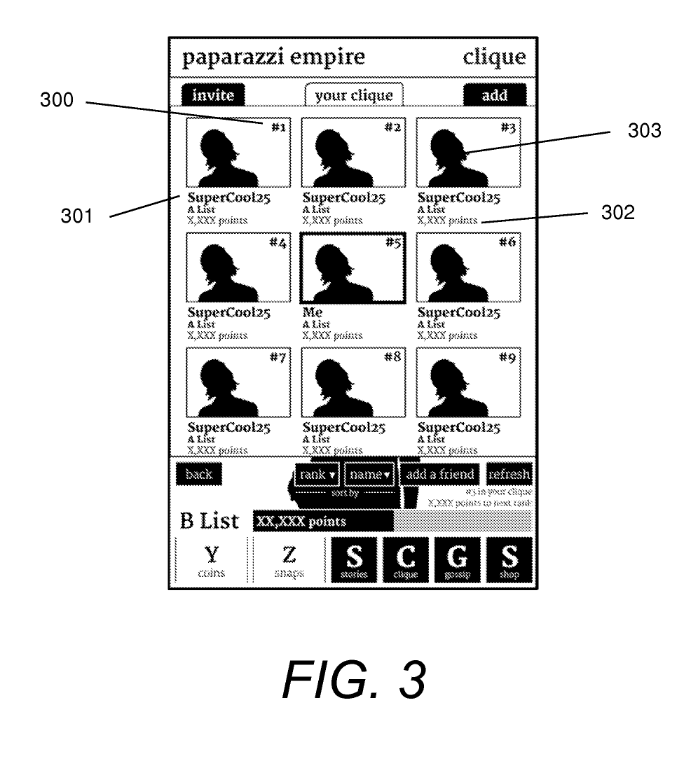

FIG. 3 shows a screenshot of the application displaying a list of friends in the player's network. In the present disclosure, the term “friends” can also be referred to by other names such as “clique” or “league”, as determined by the theme of the game, and can be used interchangeably. According to an embodiment of the present disclosure, the player can create a network of friends from an existing list such as an email address book or a social network such as FACEBOOK®. The player can name the network of friends according to the game's theme. Once the player invites his friends to join the network, the player can earn a badge. The listing of friends will appear in order of current weekly point ranking, and displaying friend's name (301), current rank (300), current status, point total (302), and a headshot of the avatar (303) of that friend. Each listing of friend can be clicked on to view the friend's full profile.

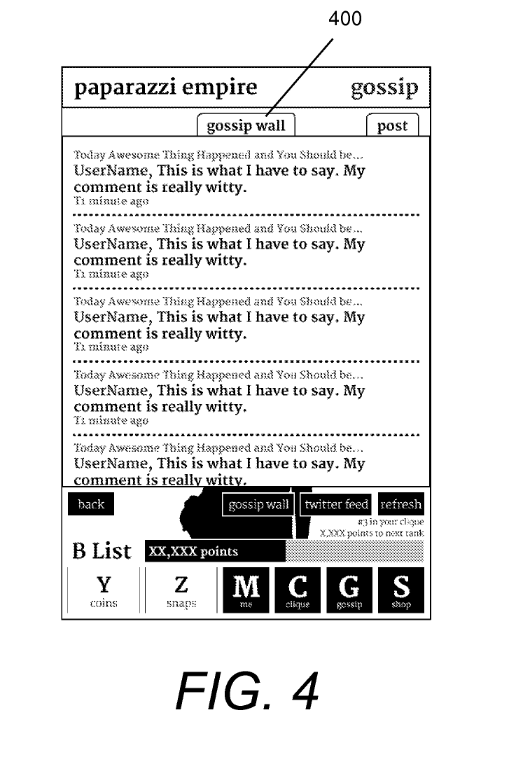

In some embodiments, each player can have a message board as shown in FIG. 4 with an exemplary Gossip Wall (400) such the each of the players can post messages or comments on their friends' message boards. In cases where the players do not want to post messages to the message board, they can send private messages or have a private chat session with each other so that other players cannot see their messages.

In some embodiments, the player can join a group, whereby once a player has attained a certain status or point value, they may become affiliated with a special group, such as a paparazzi group. Alternatively, a player may start their game play as a member of a group before they have any status or revenue.

Players can have the ability to call up game instructions, which can appear in the form of a pop up bubble or cloud. The instructions can comprise a tutorial for the players that teaches them about the screen layout and detailed functionality of each of the icons and buttons, how to find news stories, how to take a photo, value of the various badges that can be earned, how to play a mini game, and how to purchase virtual goods, how to invite friends to the game.

The players will be able to post feedback/suggestions in a real-world forum. The game can also generate a blog that will provide information about the game, new products, and updates on the company. Players may even have chances to win real world prizes, including donations to different charities, merchandise from advertisers, day with real paparazzi, tickets to premieres and industry events (e.g., Oscars, Emmys). Such contests can be collaborative (within team) or competitive (with other agencies/teams), and can be conducted by the game developer, or by a service partner such as a service provider, advertiser, or other third party partners.

Various metrics can be used to keep track of each player's or team's progress. A market analytics or intelligence service, such as COMSCORE® or KONTAGENT®, can be used to measure unique users, impressions, reach, composition, time spent, return rate, frequency of play, and money spent on virtual goods, by demographic data.

In some embodiments, the game can have a social networking page such as, for example a FACEBOOK® page. Such social networking page can be a central location for information about the game is posted. For example, the webpage can comprise various status and information of the game such as the highest scoring playing, highest ranked person, player of the day, which player got the first shot of the most-snapped story, stories with the highest percentage of each opinion, announcements of new virtual goods, voting mechanisms, posting comments about the games, and marketing for the game.

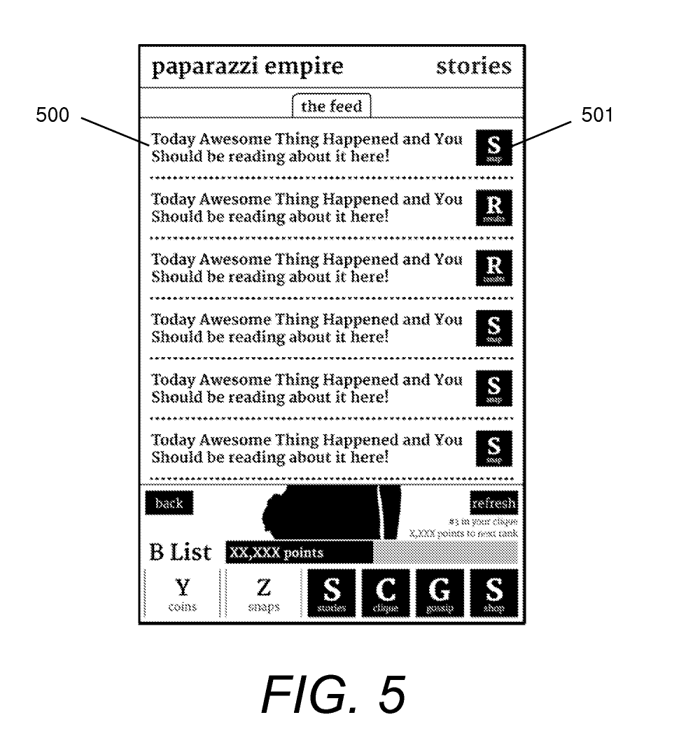

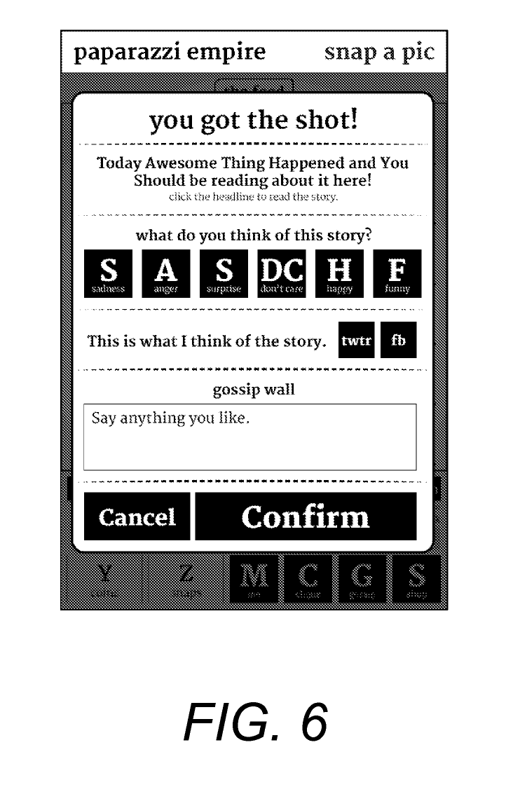

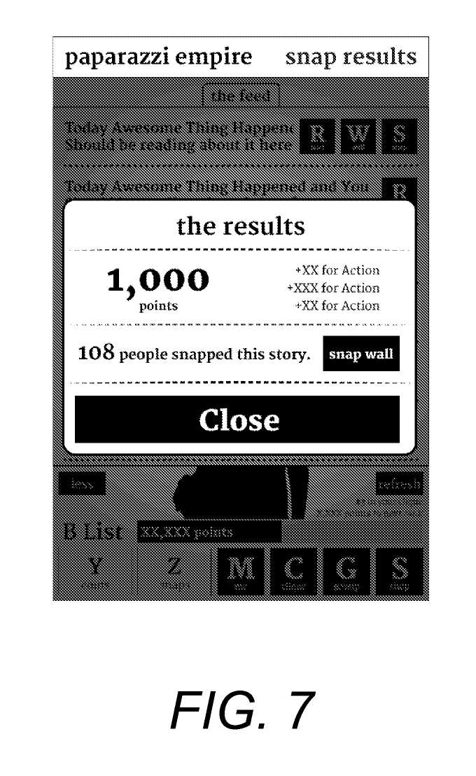

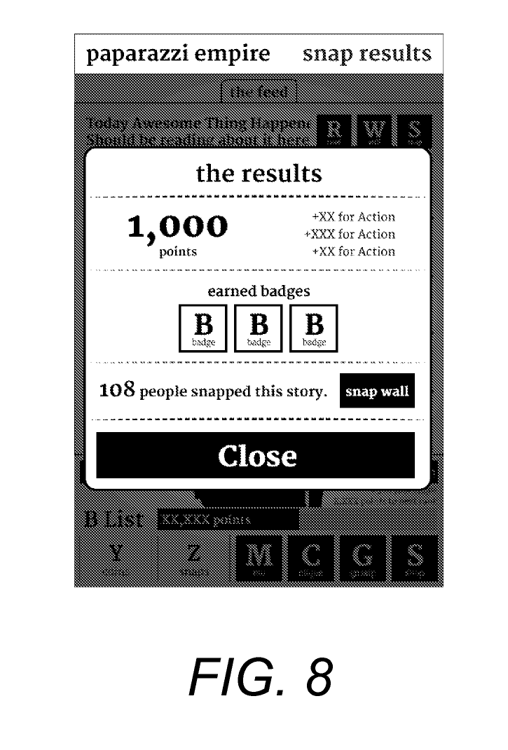

As described earlier, the object of the game is to select real world news stories by taking a photo of the news story. Such news stories can be provided to the game by a real-time feed by sources like news aggregators. By way of example and not of limitation, news can include celebrity gossip, sports, music, and politics. By taking a photograph of the news story, the players can earn points and/or badges according to a set algorithm, and by earning points and/or badges, the players can achieve higher status (e.g., A-List, B-List), for example, based on weekly goals, or by earning more badges and/or points. Points can also determine group ranking based on a set time periods, thus resulting in additional rewards for the players and/or the groups. FIG. 5 shows a screenshot of an exemplary news feed. Next to the news headline (500) is an icon that allows the player to take a photo. Once the player snaps a photo, a confirmation screen will be displayed as shown in FIG. 6. The player can hit “confirm” and a results page will be displayed on the screen showing the points earned, as shown in FIG. 7. If a badge was earned, then the screenshot shown in FIG. 8 will be displayed. Optionally, the players can purchase a time travel feature in the virtual goods store which can allow the player to snap photos of expired news.

In some embodiments, the players can snap real world pictures of celebrities out in town and upload the picture to a picture wall within the game where other player can up-vote or down-vote each picture. Playing submitting pictures having the most up-vote can earn points. In situations where players submit fake or photoshopped pictures of celebrities, other player will have the opportunity to down-vote the picture. Repeated offender can receive a Liar Badge and lost points. If a player takes a real world picture with the celebrity, the player will be awarded a high value badge.

The game can derive revenue through a variety of sources, including providing virtual goods for purchase, advertising, and additional fees (e.g., upgrade fees) to users. Virtual goods for purchase within the game or associated with the social networking platform, and can include clothes, accessories, pets, items, backgrounds, game enhancements, and more. Advertising integrated with the game can also account for revenue generated by the game. The advertising can offer four major elements of a consumer journey: awareness, consideration, investigation and purchase intent. Awareness can include branding efforts such as integrations, skins, and logos. Consideration can include distinct messaging opportunities through banners (flash and media-rich), video or other multimedia content. Investigation provides a deeper engagement through virtual good equity exchange (e.g., cars/motorcycles, cameras, entertainment, food and beverages, restaurants, telecom, clothes, fashion accessories in exchange for media viewing/interaction), mini game creation, or branded worlds. Finally, purchase intent can include value add giveaways and exclusivities. Execution of the game can include partnerships with vendors that sell media in-and-around the game based on activity-targeting capabilities.

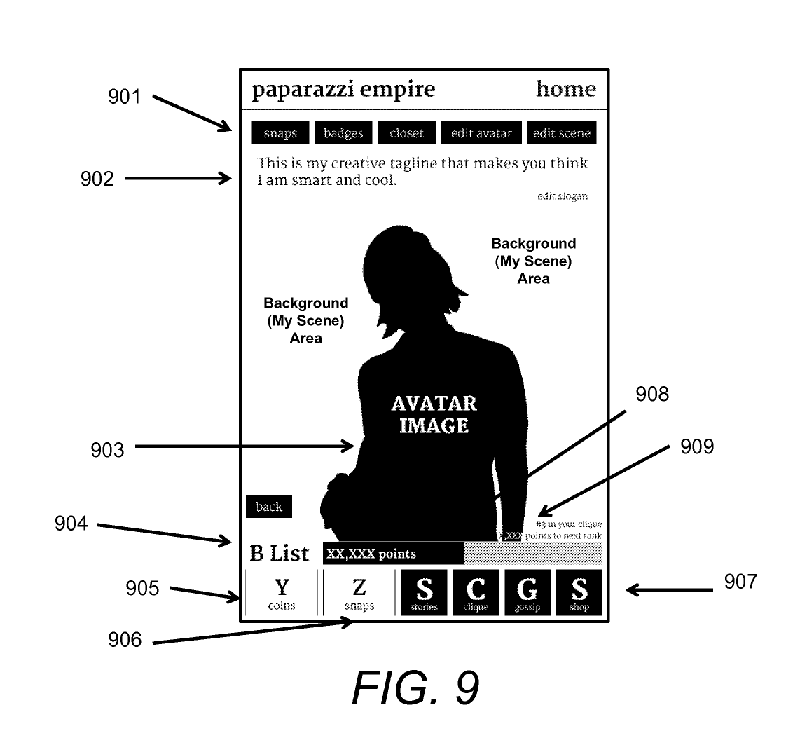

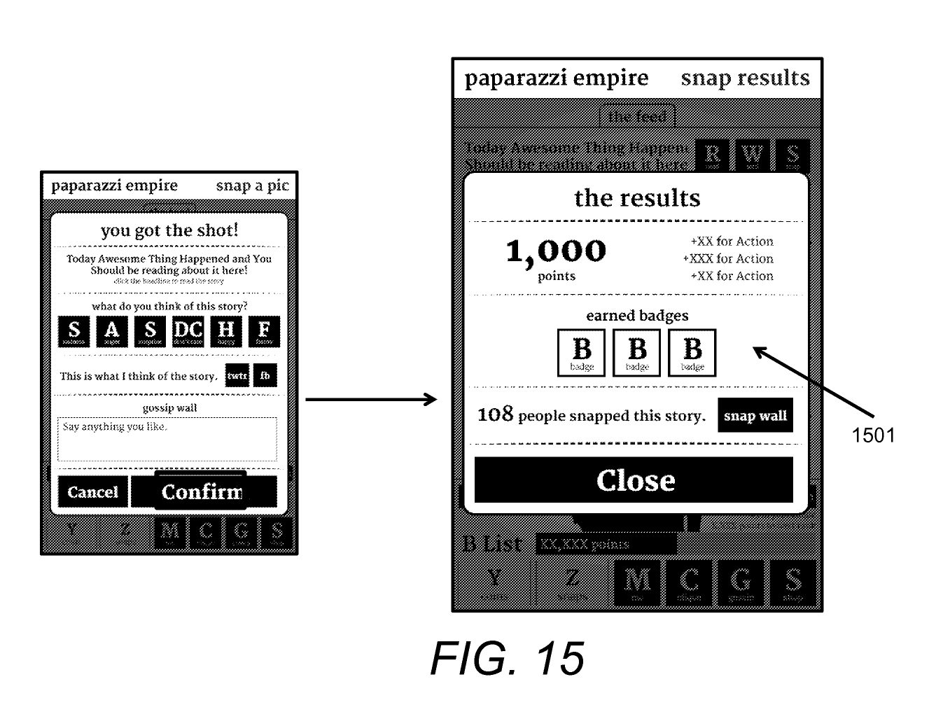

FIGS. 9-22 show a plurality of screenshots according to an exemplary implementation of the game as described in the present disclosure. More specifically, FIG. 9 shows a home screen of the game. Towards the top of the home screen is a series of buttons (901) to view the player's history. By way of example and not of limitation, the buttons (901) in FIG. 9 can comprise stories snapped (snaps), badges earned (badges), avatar items purchased (closet), a button to edit the avatar (edit avatar), and a button to edit the background (edit scene). The player's customizable tagline or slogan (902) can be displayed below the series of buttons (901). A customized avatar (903) created by the player is displayed on the bottom half of the screen. The current status (904) of the player (e.g., B-List) is shown in a status bar below the avatar. The bottom left side of the display shows the current total of coins that are available for the player to use in the virtual store (905), and the number of pictures that the player has snapped (906) within a set time period. The bottom right side of the screen shows four different buttons which can change the screen to display the player's personal profile (“me” page), the players friends (“clique”), in-game commenting and social networking (e.g., TWITTER®) page, or the virtual store. The player's overall point total (908) and the number of point needed by the player to achieve the next status rank (909) are also shown.

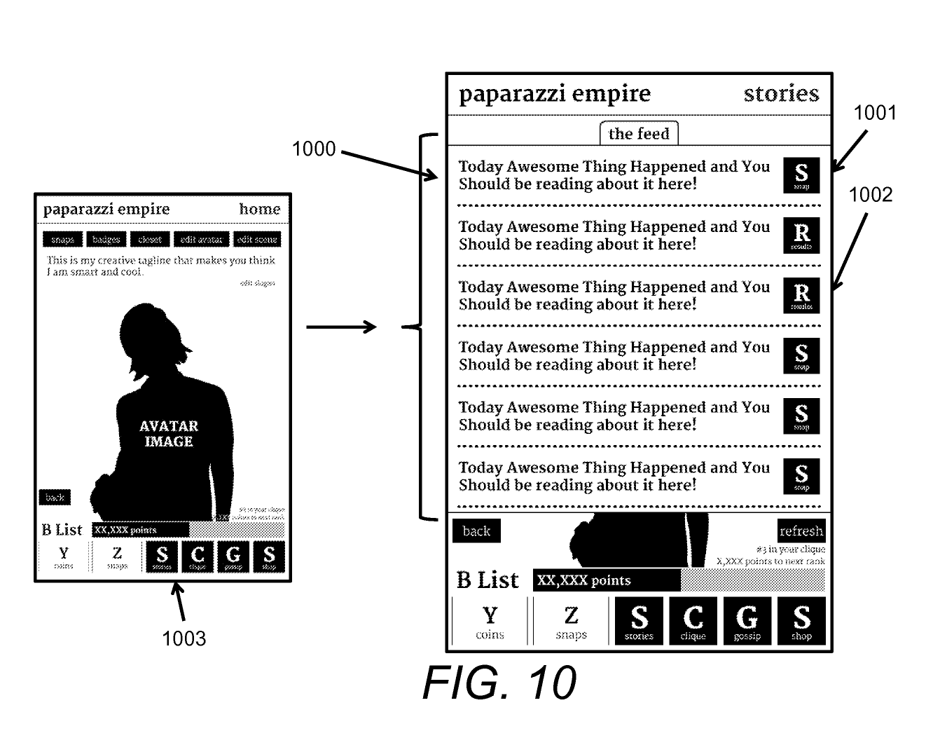

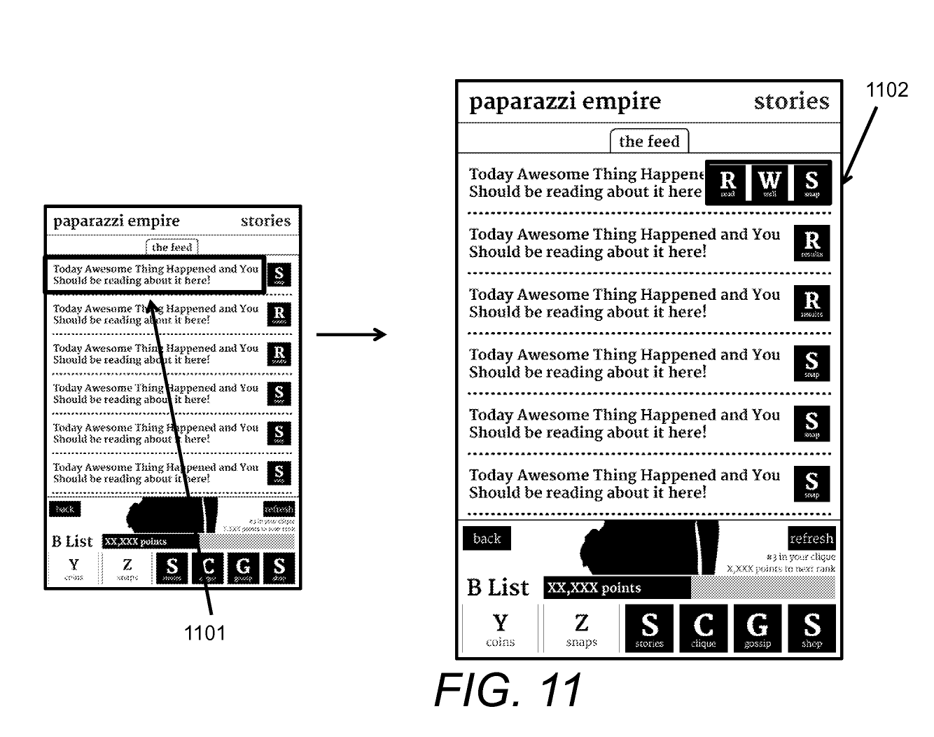

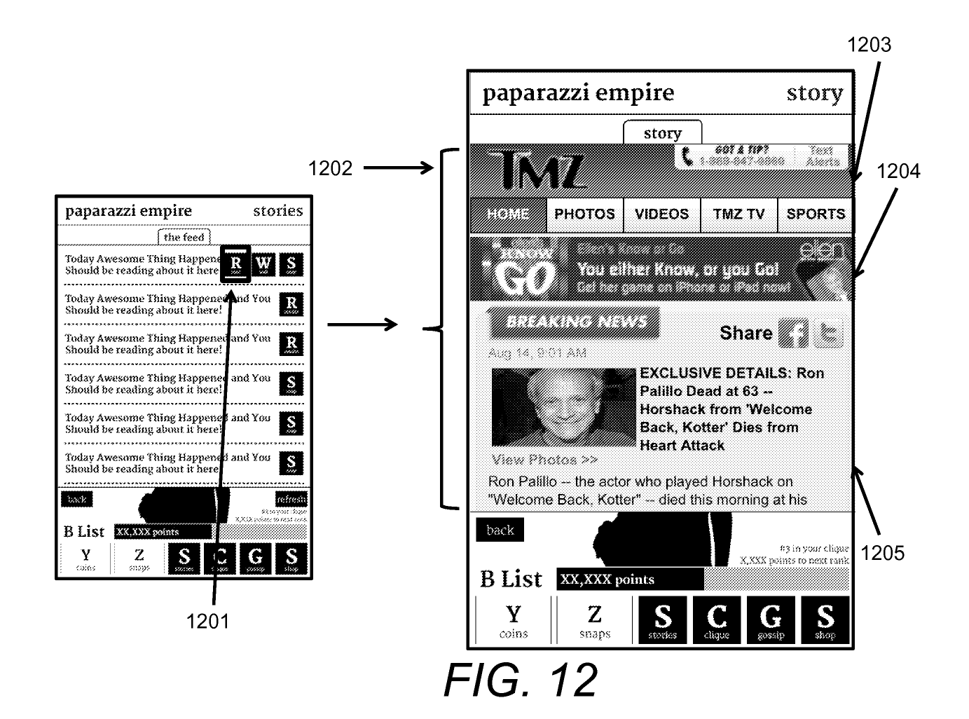

From the home screen, the player can select the “stories” icon (1003) from the bottom of the home screen as shown in FIG. 10, which will change the display to show a list of headlines (1000). If the headline shows a “snap S” (1001), then that story has yet to be snapped, while a “results R” (1002) indicates that the story has already been snapped. When the player clicks on the news headline (1101) as shown in FIG. 11, additional buttons “read R” and “wall W” (1102) are displayed in addition to “snap S”. If the “read R” (1201) as shown in FIG. 12 is pressed, a webshot (1202) of the story is displayed. When the webshot (1202) is displayed, a header or a logo of the content provider (1203) can be shown at the top along with advertisement (1204) and the actual new story (1205), which are both owned by the content provider. In other words, the news article and the webshot are provided directly by the content provider.

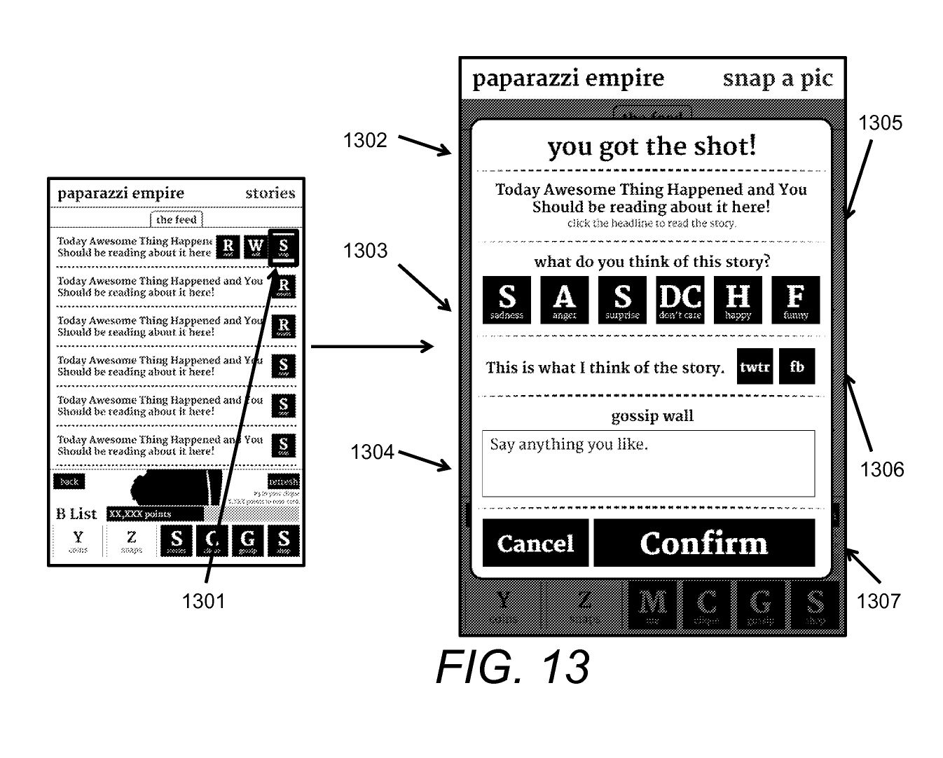

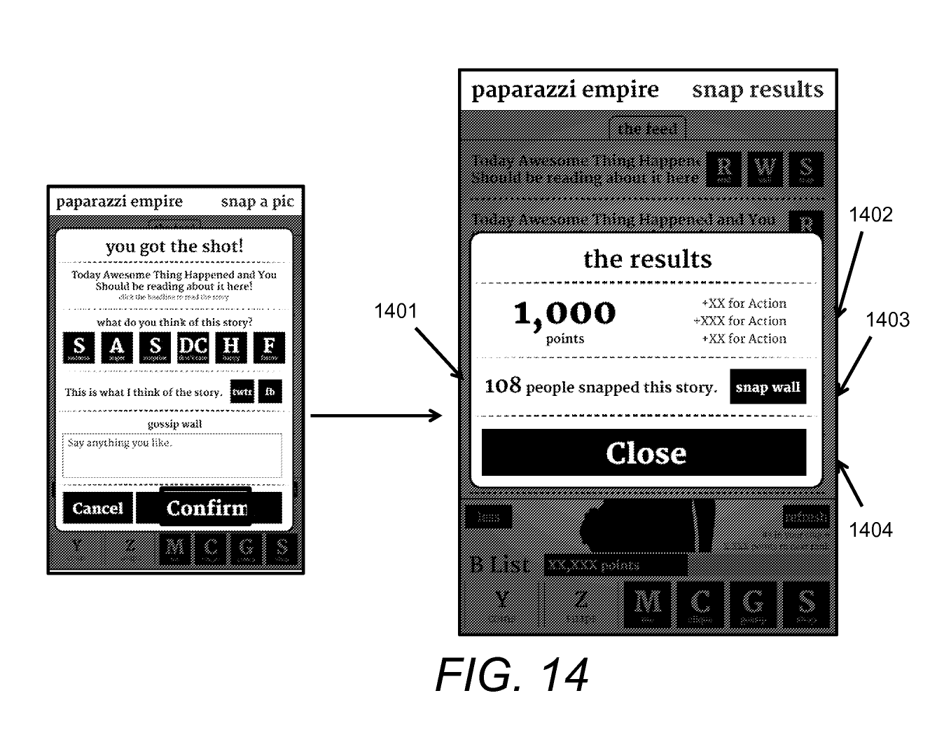

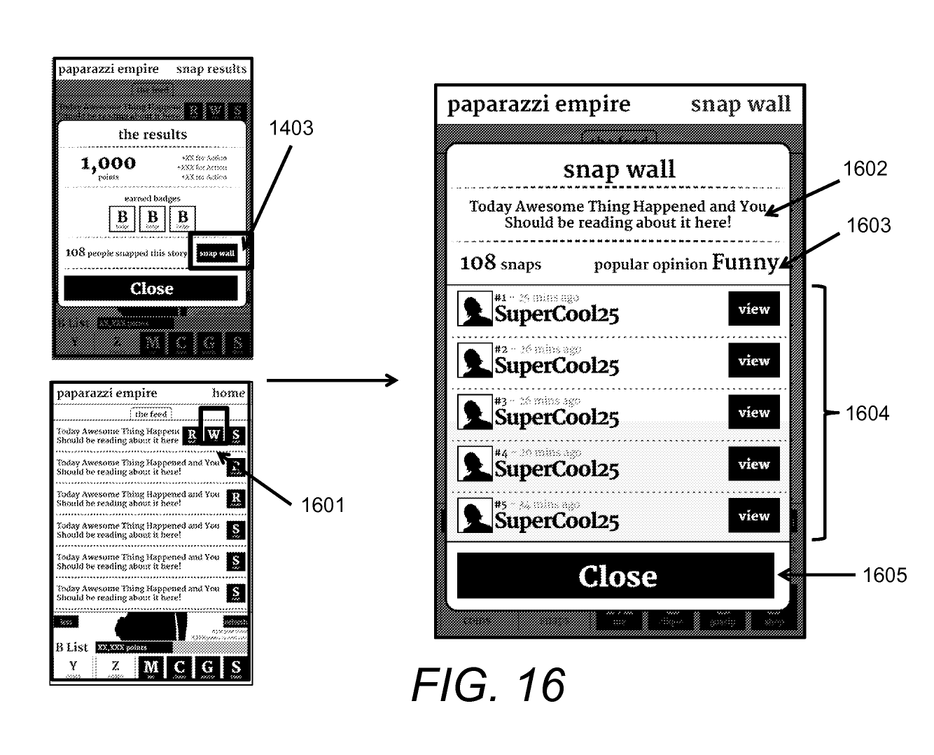

If the “snap S” (1301) button is pressed as shown in FIG. 13, the screen will display a “Snap a Pic” page (1302) where the player is provided with a selection of buttons (1303) that allows the player to state an opinion of the headline (e.g., sadness, anger, surprise, don't care, happy, funny). The confirmation page (1302) will also display the headline (1305), which can be clicked again to read the story. The player can also make a comment on the gossip wall about the story or the player's snapping action by typing comments in a comment box (1304). The player can optionally post an update about his action (e.g., snapped a picture, opinion) on social media sites but clicking on icons (1306). Finally, the player can click on “cancel” or “confirm” to cancel or confirm, respectively, the player's snap actions. If the player hit “confirm”, the screen will display the “Snap Results” screen as shown in FIG. 14. The “Snap Results” page can display the number of people that snapped this particular story (1401) and the player's total points (1402), which also shows a breakdown how such points were earned. If the player clicks on the “snap wall” button (1403), the player will be taken to the “snap wall” page, which will be described later in FIG. 16. Similarly to FIG. 14, if the player hits “confirm” and is badges are earned as a result of taking the picture, the “Snap Results” page will also display the types of badges earned (1501).

As mentioned earlier, the “snap wall” button (1403) can be selected from either the “Snap Results” page as shown in FIG. 14, or from the home page (1601), and the screen will display the “Snap Wall” page as shown in FIG. 16. The “Snap Wall” page shows the headline (1602), the most popular opinion of the headline (1603), and a list (1604) of the other players that have also snapped a picture of this story. Clicking on the “close” icon (1605) will return to the home screen.

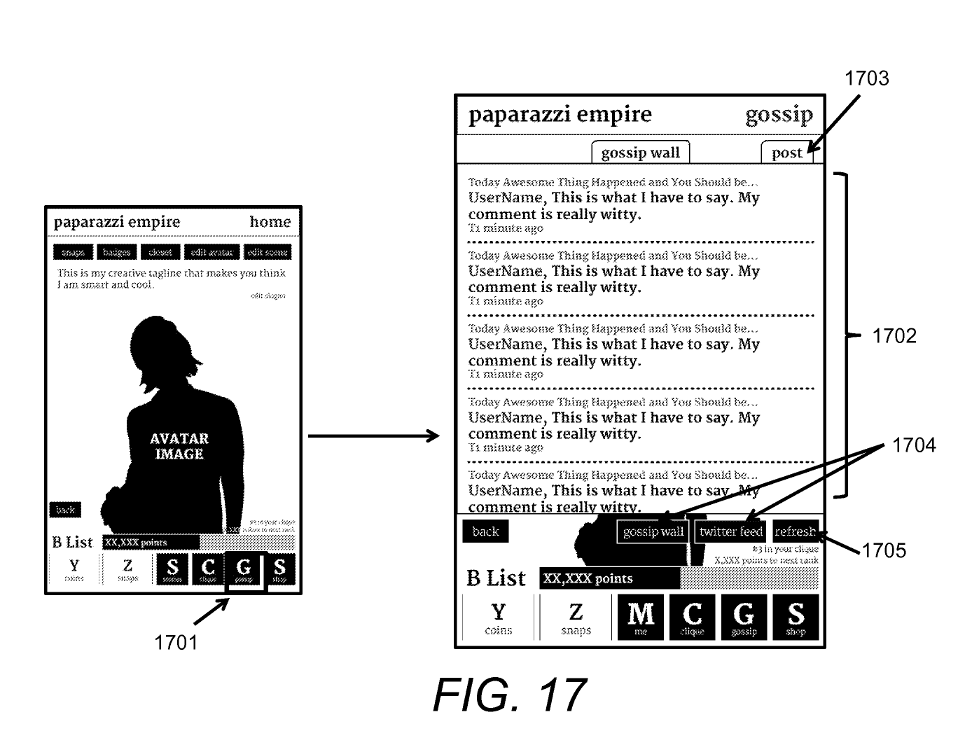

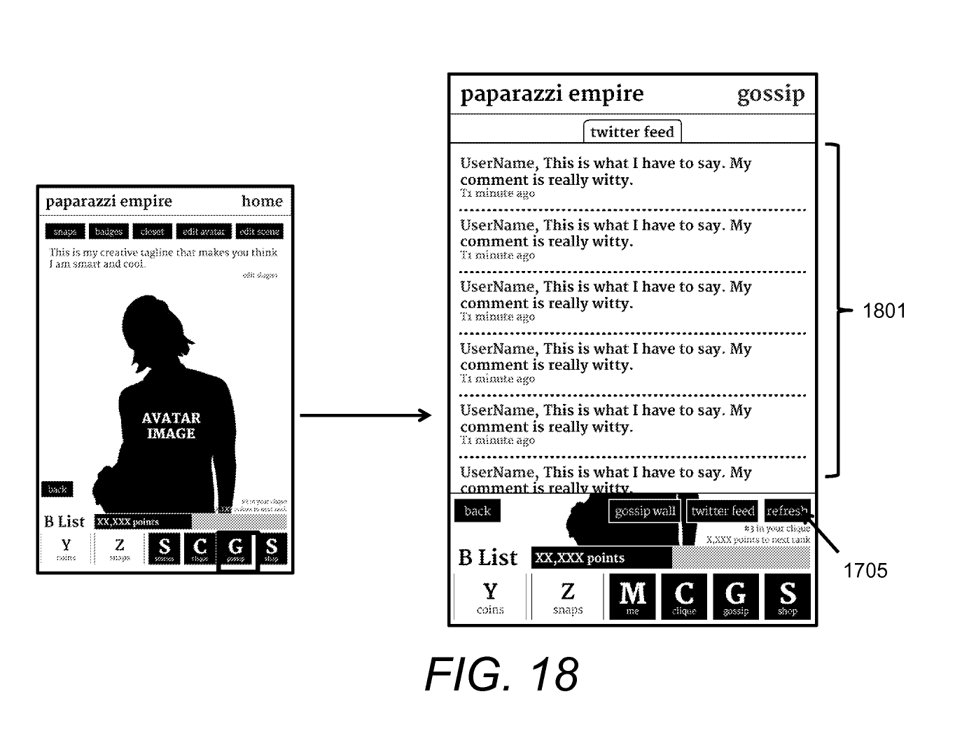

Turning back to the home screen, if the player clicks on the “gossip” icon (1701) as shown in FIG. 17, the gossip wall will be displayed showing a list of postings (1702). The player can also post additional gossip (e.g., comments) by clicking on “post” (1703). The bottom of the screen shows a “gossip wall” and a “twitter feed” icon that allows the player to toggle between the “gossip wall” page and the “twitter feed” page, as shown in FIG. 18. Furthermore, the player can click on the “refresh” icon (1705) to refresh either the “gossip wall” page or the “twitter feed” page. On the “twitter feed” page of FIG. 18, an aggregation of posting from a social media site, e.g., TWITTER® is shown, featuring the game's hashtags.

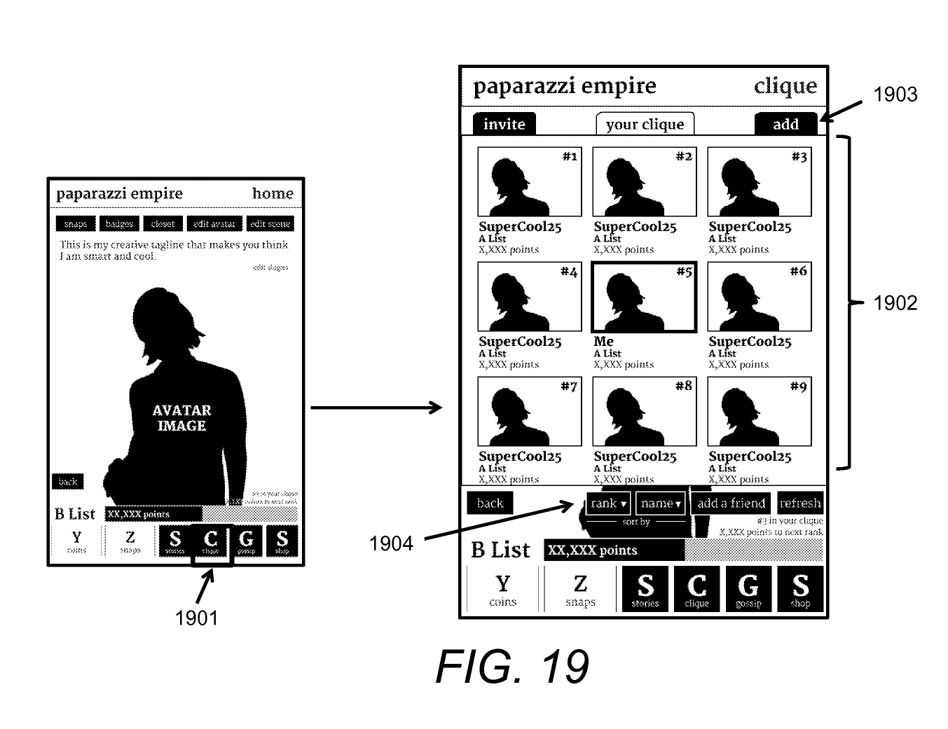

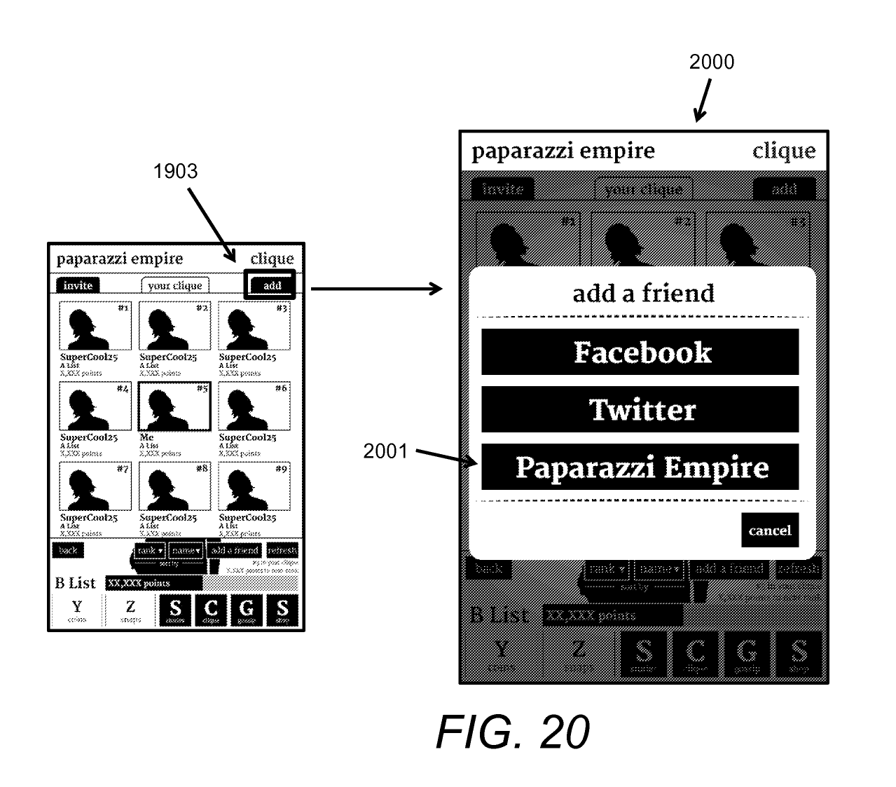

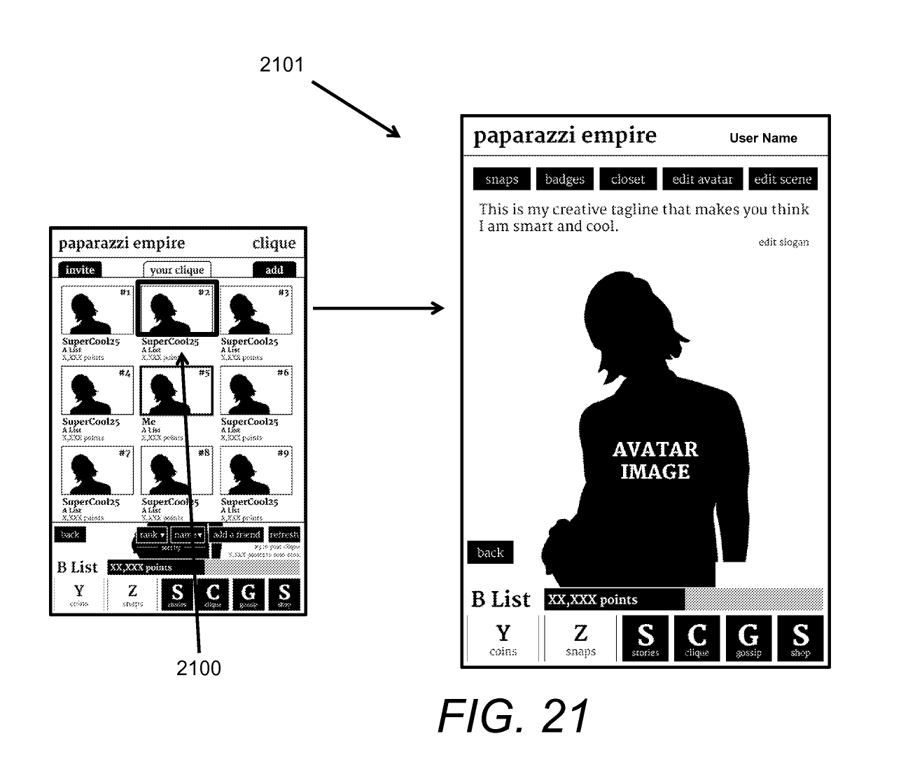

Again, turning back to the home screen, if the player clicks on the “clique” icon (1901) shown in FIG. 19, a list of the player's friends can be shown (1902), displaying the friends' real-time point ranking, current point total and status level. Optionally, the player can switch the list of friends between a list view or a grid view, and further sort the list (or grid) of friends based on ranking or alphabetically (e.g., by the players' names) by selecting the sorting icon (1904). The player can add additional friends by clicking on the “add friend” button (1903), which will display the “add friend” screen (2000) shown in FIG. 20. By way of example and not of limitation, the player can add friends from other social networks such as, FACEBOOK®, TWITTER®, or select from a list within the game itself (2001). The player can click on an icon of one of the friends from the list (2100) as shown in FIG. 21 to view that friends' home screen (2101).

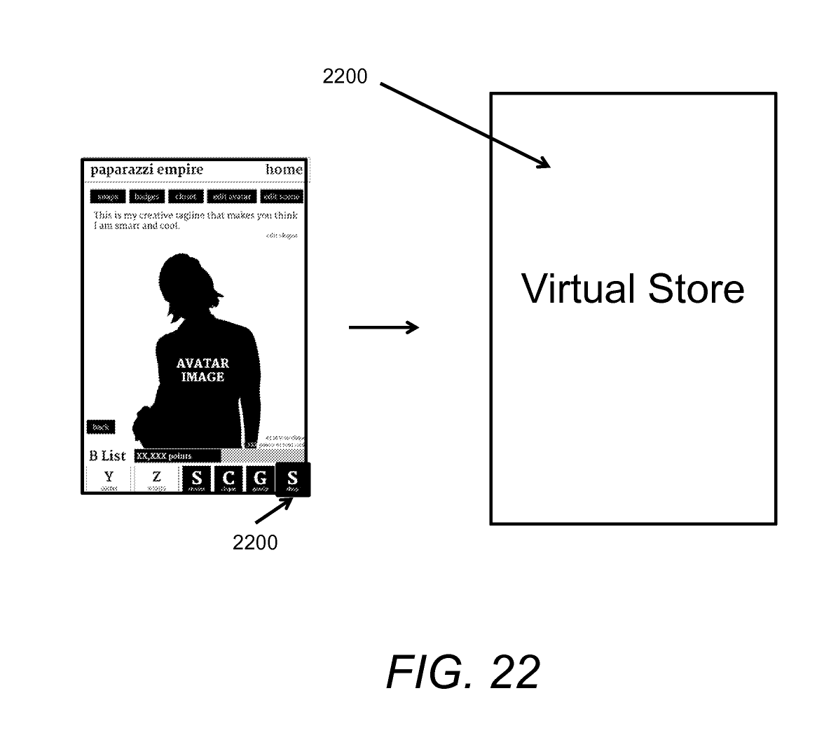

Turning back to the home screen again, the player can select the “shop” icon (2200) as shown in FIG. 22 to display the virtual store (2201), as described earlier. Although an exemplary method of implementing the game is described as various embodiments in the present disclosure, a person skilled in the art would recognize that other variations are possible.

Some or all of the functional operations described in the present disclosure can be implemented in digital electronic circuitry, or in computer software, firmware, or hardware, including the structures disclosed in this specification and their structural equivalents, or in combinations of them. The embodiments can be implemented as one or more computer program products, e.g., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the present disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments may also be provided in combination in a single embodiment. Conversely, various features which, for brevity, are described in the context of a single embodiment may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular embodiments have been described herein the present disclosure. Other embodiments are within the scope of the following claims. For example, the steps recited in the claims can be performed in a different order and still achieve desirable results. In addition, embodiments described herein are not limited to database architectures that are relational. For example, various embodiments can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

The examples set forth above are provided to give those of ordinary skill in the art a complete disclosure and description of how to make and use the embodiments of the present disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A computer-implemented method for playing a game comprising:
receiving, in a server that supports a gaming platform, a plurality of real-time data feed related to a specific category;
aggregating, by the server, the plurality of real-time data feeds to present an aggregated data feed related to the specific category;
displaying, on a client computer the aggregated data feed of the specific category;
receiving a selection by a player, of one or more data feed of the aggregated data feed; and
providing points by the server to the player upon receiving the selection of the one or more data feed based on set rules.

2. The method according to claim 1, further comprising receiving, by the server a listing of a network of friends, thus adding a network of friends to play the game against, the network of friends being provided from a social network.

3. The method according to claim 1, further comprising selling, by a virtual store on the server, virtual goods to the player, the player using the virtual goods to earn further points.

4. The method according to claim 1, wherein the selection is performed by virtually clicking on an icon of the data feed on a graphical user interface of a client computer.

5. The method according to claim 4, wherein the virtually clicking on an icon comprises indicating to the server of the player's selection of the one or more data-feed.

6. The method according to claim 1, further comprising providing badges, by the server to the player based on a number of data feed selected and a type of data feed selected by the player.

7. The method according to claim 1, further comprising providing, by the server to the player, virtual money for use in a virtual store on the server.

8. The method according to claim 1, wherein the specific category is selected from the group consisting of: real people, real celebrities, politics, sports, music, exercise, and food.

9. The method according to claim 1, where the real-time data feed is provided by third party data aggregators.

10. The method according to claim 1, wherein the set rules comprise a point calculating algorithm based on popularity of the selected data-feed, and competitive rank of the player.

11. The method according to claim 1, further comprising executing, by the server, the game for the client computer.

12. The method according to claim 1, further comprising:
receiving, in the server, map data from a map source to generate a map of a geographical area;
translating, by the server, at least some of the aggregated data feed into location data associated with the geographical area;
integrating, by the server, the location data with the map of the geographical area; and
transmitting, by the server, the map integrated with location data to a client computer that is playing the game.

13. A computer-implemented system for playing a real-time reality based data game, the system comprising:
a server comprising a live data feed aggregator adapted to receive a plurality of real-time data feeds related to a specific category, and aggregates the plurality of real-time data feeds into an aggregated data feed;
one or more client computers having a display, the one or more client computers being adapted to receive user input to play the game; and
a game engine that executes the game using the display, the game engine communicating with one or more client computers for receiving user input to play the game.

14. The system according to claim 13, wherein the client computer is selected from the group consisting of: a smartphone, a desktop computer, a laptop computer and a tablet.

15. The system according to claim 13, wherein the server is a hosted server.

16. The system according to claim 13, further comprising: an ad server adapted to receive advertisement information from advertisers to the server, the server adapted to display the advertisement information on the display of the client computer.

17. The system according to claim 13, further comprising:
a mapping engine adapted to receive map data from one or more map sources; and
a location translator adapted to extract at least some information from the aggregated data feed to generate location information relevant to the specific category and based on the map data, and a user interface being adapted to generate a display of the map data with the location information.

18. The system according to claim 13, further comprising a game channel, the game channel adapted to provide mini-games within the real-time reality data based game for players to earn additional point.

19. The system according to claim 13, further comprising a database associated with the server adapted to store player information and player performance data from the executed game.

20. A computer-implemented system for playing a game, the system comprising:
a client computer having a screen for displaying a series of graphical user interfaces, the graphical user interfaces comprising a home screen for displaying an avatar image, a list of real-time data feed, and a plurality of navigational buttons for navigating from the home screen to a plurality of different graphical user interface pages,
wherein the list of real-time data feed comprises headlines of real-world news stories associated with a specific category,
wherein the screen is adapted to display additional navigational buttons when the headline from the list of real-time data feed is selected by a player playing the game, the additional navigational buttons adapted to allow the player to read the selected real-world news, comment about the selected real-world news, and/or virtually select the selected real-world news, and
wherein the player earns game points by virtually selecting the selected real-world news.
